(19) United States
(12) Patent Application Publication
(10) Pub. No.: US 2026/0276109 A1
(43) Pub. Date: Sep. 17, 2026

(54) PIPING CONNECTION SYSTEM AND METHOD OF USE

(71) Applicant: Springseal, Inc., Ravenna, OH (US)

(72) Inventors: Mark Knapp, Ravenna, OH (US); Timothy Toliver, Macedonia, OH (US); Kenny Reffner, Tallmadge, OH (US)

(73) Assignee: Springseal, Inc., Ravenna, ME (US)

(21) Appl. No.: 19/564,391

(22) Filed: Mar. 12, 2026

Related U.S. Application Data
(60) Provisional application No. 63/770,682, filed on Mar. 12, 2025.

(51) Int. Cl. F16L 5/02; F16L 25/00

(52) U.S. Cl. CPC F16L 5/025; F16L 25/0054

(57) ABSTRACT

A piping connection system is described herein. The piping connection system includes an annular adaptor body a unitary configuration that is to be circumferentially positioned around a connecting pipe during use. The annular adaptor body further includes at least one cleat extending along an inner wall of the annular adaptor body, the at least one cleat transverse to the inner wall, and a connecting device extending from an exterior surface of the annular adaptor body, the connecting device for coupling to support structure. The piping connection system further includes a gasket having a unitary configuration that is to be circumferentially positioned around a connecting pipe during use, the gasket in contact with the interior surface during said use.

The present application is a non-provisional application that claims priority under 35 U.S.C. § 119(e) to co-pending U.S. Provisional Application Serial Number 63/770,682 entitled PIPING CONNECTION SYSTEM AND METHOD OF USE that was filed on Mar. 12, 2025 with the United States Patent Office, the present application claims priority to said provisional application which is incorporated by reference in its entirety herein for all purposes.

### TECHNICAL FIELD

The present disclosure relates to a piping connection system and method of use, method of manufacturing, and method of attaching a mating pipe to a structure via a fluid-tight piping connection such that a connection is created between the mating pipe and the structure.

### BACKGROUND

Traditional piping systems are frequently required to connect to structures for changes in direction, changes in elevation, changes in pipe diameter, and/or to allow for thermal expansion of contraction of the pipe. Traditional connections to structures are only able to be made watertight when the pipe has a smooth exterior surface at the point or area of entry into the structure.

Ideally, pipe to structure connections would have the ability to handle shear loads that occur due to differential settlement between the structure and pipe or handle angular misalignment, which may occur after installation. Existing pipe to structure connection devices fit a limited number of pipe outside diameters, limiting the types of pipes and structures to which such existing pipe structures are functional.

Lastly, water or sewer flow exiting structures are restricted by the turbulence created by sharp corners as the flow enters the pipe. The amount of hydraulic restriction is defined by inlet loss coefficients. In recent years, pipe types have been developed with a corrugated or other irregular shaped exterior surfaces, which makes watertight connection to structures impossible. Additionally, the outside diameter of these corrugated or irregular shaped exterior surfaces varies. This variety of exterior pipe surfaces and outside diameters limits pipe manufacture’s ability to make connections to structures, thereby restricting the ability for pipe makers to enter these specialized markets. One example of a gasket design for such application, as well as for other purposes includes U.S. Patent No. 7,469,905 that issued Dec. 30, 2008, Patent No. 9,228,684 that issued Jan. 5, 2016, Patent No. 9,746,112 that issued Aug. 29, 2017 and Patent No.10,046,516 that issued Aug. 14, 2018 all assigned to SPRINGSEAL® (Streetsboro, Ohio) entitled PERMANENTLY LUBRICATED FILM GASKET AND METHOD OF MANUFACTURE (hereinafter "the '905 Patent"), which are incorporated herein by reference in their entireties.

### SUMMARY

One example embodiment of the present disclosure includes a piping connection system. The piping connection system includes an annular adaptor body a unitary configuration that is to be circumferentially positioned around a connecting pipe during use. The annular adaptor body further includes at least one cleat extending along an inner wall of the annular adaptor body, the at least one cleat transverse to the inner wall, and a connecting device extending from an exterior surface of the annular adaptor body, the connecting device for coupling to support structure. The piping connection system further includes a gasket having a unitary configuration that is to be circumferentially positioned around a connecting pipe during use, the gasket in contact with the interior surface during said use.

Another example embodiment of the present disclosure includes a piping connection system, the piping connection system including an annular adaptor body having a unitary configuration that is to be circumferentially positioned around a connecting pipe during use, the annular adaptor body further comprising a rounded inlet at a leading end of the adaptor body, the rounded inlet in contact with a leading face of the connecting pipe during use, wherein, the rounded inlet extending annularly around the leading face of the adaptor body and a gasket having a unitary configuration that is to be circumferentially positioned around a connecting pipe during use, the gasket in contact with the interior surface during said use.

Yet another example embodiment of the present disclosure includes a piping connection system. The piping connection system includes an annular adaptor body having a unitary configuration that is to be circumferentially positioned around a connecting pipe during use, the annular adaptor body further comprising a stop at a terminal end of the adaptor body, wherein, the stop extends parallel to an exterior surface of the adaptor body and extending at least one of partially or totally around the annular adaptor body, and a gasket having a unitary configuration that is to be circumferentially positioned around a connecting pipe during use, the gasket in contact with the interior surface during said use.

### BRIEF DESCRIPTION OF THE DRAWINGS

The foregoing and other features and advantages of the present disclosure will become apparent to one skilled in the art to which the present disclosure relates upon

consideration of the following description of the invention with reference to the accompanying drawings, wherein like reference numerals refer to like parts unless described otherwise throughout the drawings and in which:

FIG. 1 is a cross-section of an adaptor body coupled to a connecting pipe and existing structure, in accordance with one example embodiment of the present disclosure;

FIG. 2 is a cross-section of an adaptor body coupled to a connecting pipe and existing structure, in accordance with another example embodiment of the present disclosure;

FIG. 3 is a cross-section of an adaptor body coupled to a connecting pipe and existing structure, in accordance with another example embodiment of the present disclosure;

FIG. 4 is a cross-section of an adaptor body coupled to a connecting pipe and existing structure, in accordance with another example embodiment of the present disclosure;

FIG. 5 is a partial sectional-side view of an adaptor body coupled to a connecting pipe and existing structure, in accordance with another example embodiment of the present disclosure;

FIG. 6 is a top view of an adaptor body, in accordance with another example embodiment of the present disclosure;

FIG. 7 is a sectional view of an adaptor body taken along lines A-A in FIG. 6;

FIG. 8 is a cross-section of an adaptor body coupled to a connecting pipe and existing structure, in accordance with one example embodiment of the present disclosure; and

FIG. 9 is a partial sectional-side view of an adaptor body coupled to a connecting pipe and existing structure, in accordance with another example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The present disclosure relates to a piping connection system and method of use, method of manufacturing, and method of attaching a mating pipe to a structure via a fluid-tight piping connection such that a connection is created between the mating pipe and the structure.

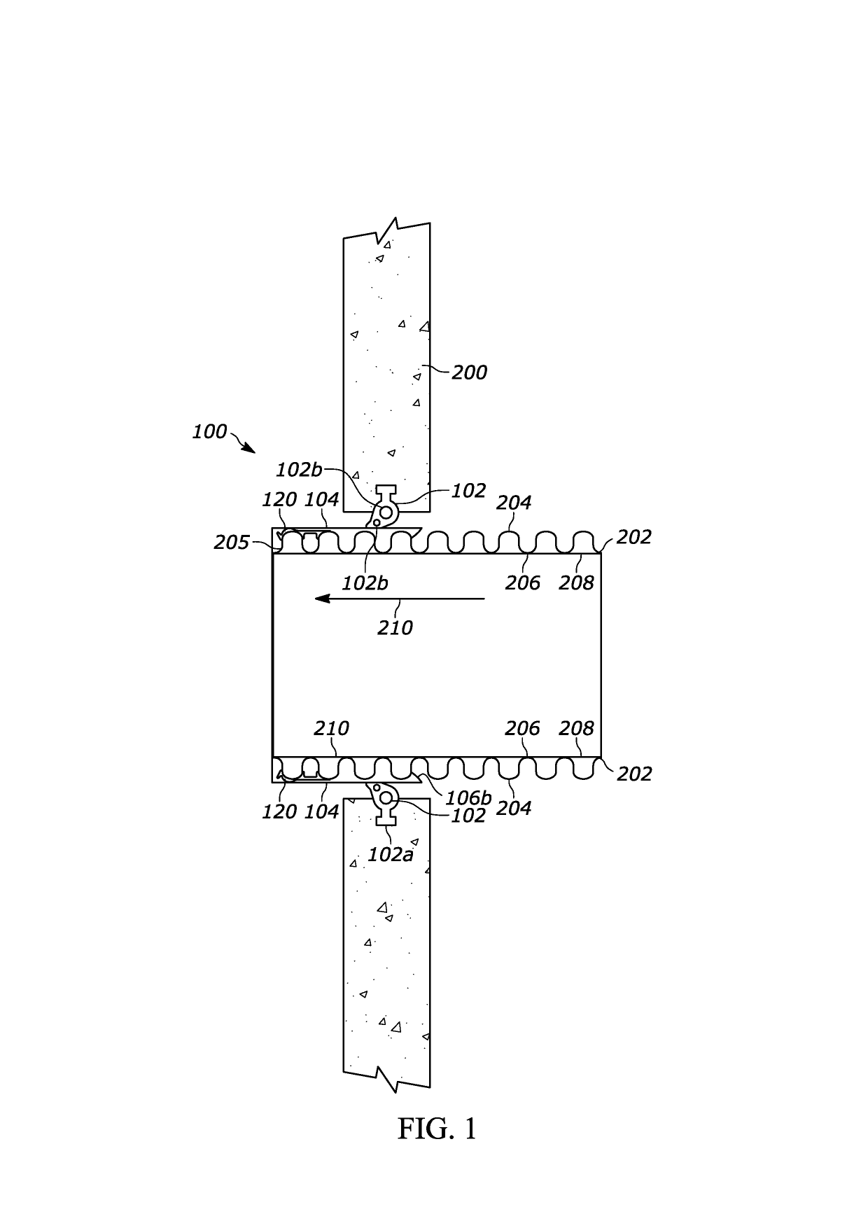

Referring to the figures, and in particular FIG. 1, which is a cross-sectional view of an assembly 100 coupled to a corrugated pipe 202, the assembly constructed in accordance with one embodiment of the disclosure forming a sealing and fluid-tight connection between the assembly 100 and the first corrugated pipe 202. The assembly 100 includes a connector device 102 couplable to a connecting structure 200, and an adaptor body 104 coupled to the connector device. The adaptor body 104 defines one or more locking cleats 106 coupled to and extending laterally away from the adaptor body 104. In one example embodiment, a gasket 120 is coupled to the adaptor body 104. In another example embodiment, the gasket 120 is a separate or discrete structure from the adaptor body 104. In one example embodiment, the adaptor body 104 defines an interior surface 104a and an exterior surface 104b. In this example embodiment, the interior and exterior surfaces 104a, 104b are substantially smooth.

In this example embodiment, the corrugated pipe 202 defines a series of gasket corrugations defining alternating peaks 204 and valleys 206. In this example embodiment, the gasket corrugations are transverse corrugations that extend circumferentially around the corrugated pipe 202. In one example embodiment, the valleys 206 reside on and/or are in contact with a smooth liner 208 that defines a flow path. The gasket 120 is an annular body formed of a unitary, tubular configuration that is circumferentially positioned around one or more gasket corrugations. In one example embodiment, the gasket 120 is made of one of Thermoplastic Elastomer (TPE), High Density Polyethylene (“HDPE”) and/or rigid polypropylene plastic. In one example embodiment, the gasket 120 is made of Thermoplastic Elastomer (TPE). In one example embodiment, the TPE includes polypropylene. In one example embodiment, the TPE has a range of 40 to 90 shore A. In another example embodiment, the TPE has a hardness of 55 shore A.

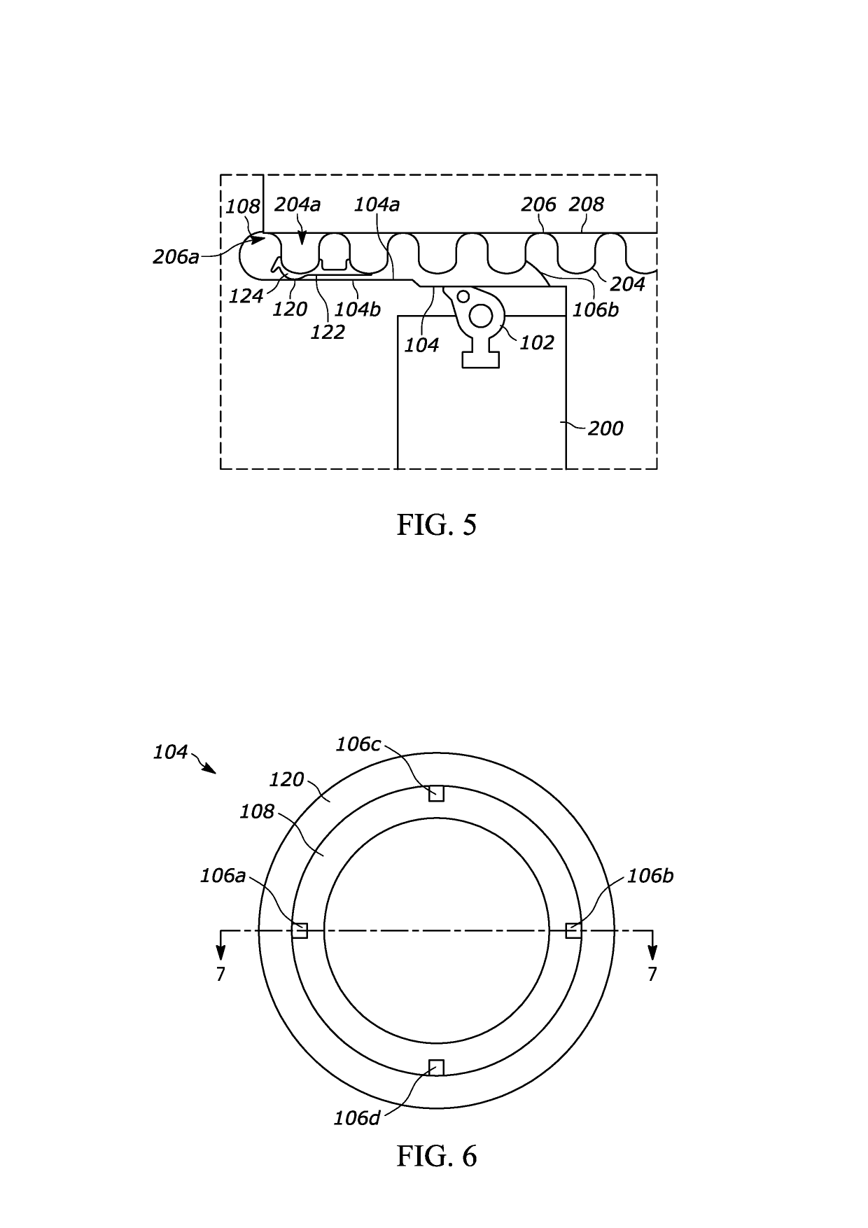

In this example embodiment, as best seen in FIG. 5, the gasket 120 defines a saddle portion 122 the extends across and partially within one valley 206 and resides at least partially over two adjacent peaks 204. The gasket 120 further defines a leading portion 124 that extends over a leading peak 204a and into a lead valley 206a, the lead valley defining a leading face 205 of the connecting pipe 202. In one example embodiment, the leading portion 124 is coupled to or in contact with the adaptor body 104 when the adaptor body is in use. In this example embodiment, the gasket 120 seals a leak path between the connector pipe 202 and the interior surface 104a of the adaptor body 104. When the assembly 100 is in use, the gasket 120 is offset from a seal point (e.g. a first end) of the connector pipe 202. The dual location of sealing points allows two pivot points thereby increasing the total allowable angular displacement of the connecting pipe 202 entering or exiting the structure 200.

In the illustrated example embodiments, the gasket 120 is annular and unitary such that it cannot be separated without destroying the gasket. In another example embodiment, the gasket 120 is annular, unitary, and formed by extruding or molding one material or multiple materials together such that the materials are integrally connected. In one example embodiment, that the materials are integrally connected such that the materials cannot be separated without destroying the gasket. While in yet another example embodiment, the gasket 120 is annular, unitary, and formed by extruding, co-extruding, tri-extruding, or multi-extruding one or more materials integrally together in a linear fashion such that the gasket has first and second ends that are integrally connected at a seam by welding, fusing, bonding, or any combination thereof to form an annular and unitary gasket, eliminating the first end and second end such that that annular, unitary, integrally connected gasket 120 cannot be separated without destroying the gasket. In another example embodiment, the integral connection of the first and second ends at the seam is substantially flash free and incapable of being detected by the human eye as would be appreciated by one of ordinary skill in the art after reviewing the present disclosure, accompanying drawings, and patent(s) owned by the assignee and/or inventor of the subject application on gaskets and joining of gaskets, which are incorporated herein by reference in their entireties.

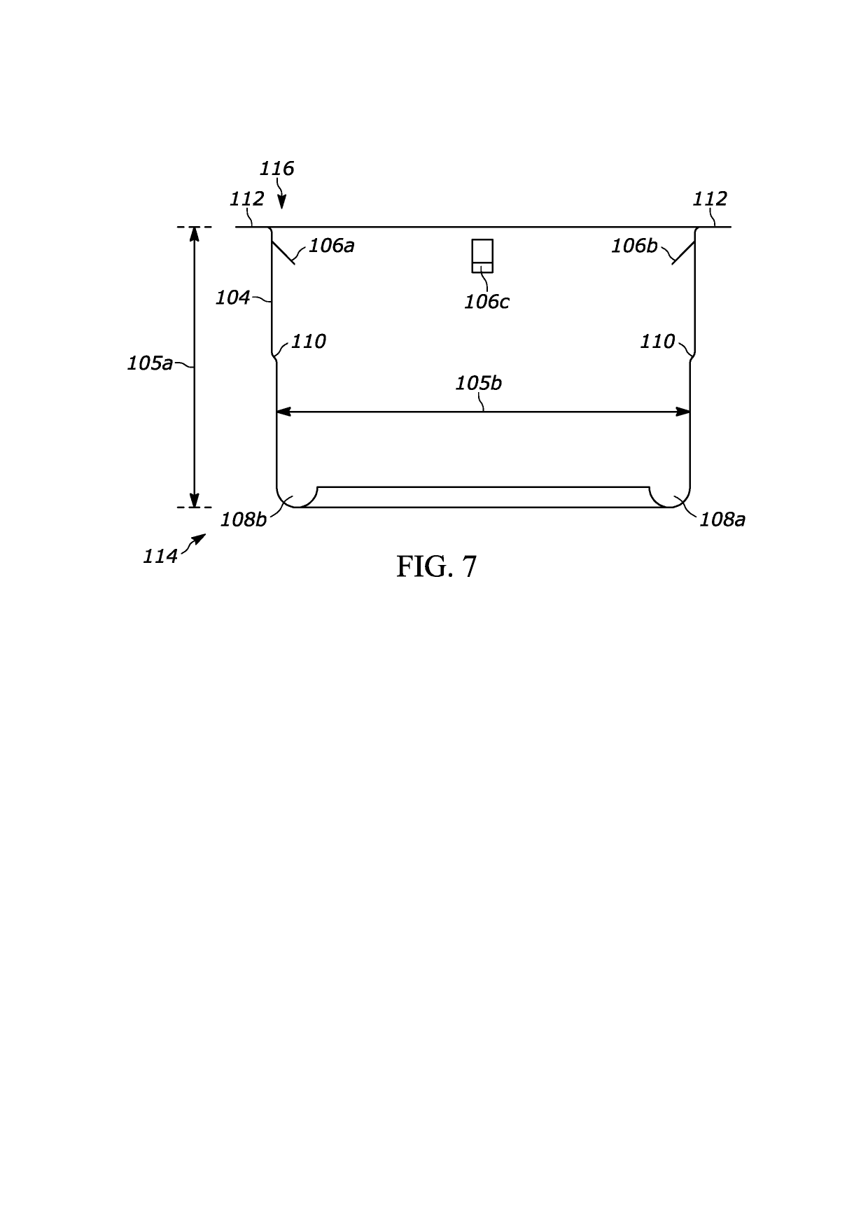

As illustrated in the example embodiment of FIGS. 1-7, the adapter body 104 is an annular body formed of a unitary, tubular configuration that is circumferentially positioned around the connecting pipe 202 and/or the gasket 120. In this example embodiment, a length 105a of the adapter body 104 is variable based upon the type of connection desired (see FIG. 7). In one example embodiment, the length 105a extends from a front end 114 to a rear end 116 of the adaptor body 104 along an assembly direction 210. In one example embodiment, the length 105a is between 6 inches and 48 inches. In another example embodiment, a width or diameter 105b of the adapter body 104 is variable based upon the size and/or shape of the connecting pipe 202 (see FIG. 7). In this example embodiment, the width or diameter 105b extends from one interior surface to the opposite interior surface 104a of the adaptor body 104 perpendicular to the assembly direction 210. In one example embodiment, the width or diameter 105b is between 10 inches and 60 inches. In one example embodiment, the adaptor body 104 is made of metal, Polyethylene, Polypropylene and/or Rigid polyvinyl chloride (PVC). In one example embodiment, the adaptor body 104 has a range of between about 80 shore A to 60 shore D. In another example embodiment, the adaptor body 104 has a hardness of 95 shore A. In this example embodiment, the adaptor body 104 is annular, unitary, and formed by hand fabrication, thermoforming, and/or injection molding of one material or multiple materials together such that the materials are integrally connected such that the materials cannot be separated without destroying the adaptor body.

In the illustrated example embodiments of FIGS. 1-7, the adaptor body 104 defines one or more locking cleats 106. In would be understood by one of ordinary skill in the art that the cleats 106 may be present or absent. In one example embodiment, such as illustrated in FIG. 6, the adaptor body 104 defines first, second, third and fourth locking cleats 106a, 106b, 106c, 106d. In the illustrated example embodiment, the first, second, third and fourth locking cleats 106a, 106b, 106c, 106d are spaced from each other approximately 90^{o}. It would be understood by one having ordinary skill in the art that different configurations of cleats and/or different numbers of cleats are contemplated. In this example embodiment, the one or more locking cleats 106 extend from the interior surface 104a of the adaptor body 104 toward the connecting pipe 202. In one example embodiment, the one or more locking cleats 106 extend one of transverse or perpendicular to the interior surface 104a of the adaptor body 104. During use and while connected to the connecting pipe 202, the one or more locking cleats 106 interact with portion of a valley 206 of a corrugation present on the connecting pipe to prevent the connecting pipe from backing out of the adaptor body 104 (e.g., from turbulence or force of liquid flowing through the connecting pipe). In one example embodiment, the one or more locking cleats 106 are formed in the adaptor body 104 during formation of the adaptor body, or in a secondary process. In one example embodiment, the one or more locking cleats 106 are formed by hand fabrication, thermoforming, and/or injection molding. In one example embodiment, the one or more locking cleats 106 are formed from metal, Polyethylene, Polypropylene and/or Rigid PVC.

In the illustrated embodiment of FIG. 1, the adaptor body 104 is coupled to the connection device 102. In one example embodiment, the connection device 102 is a seal, made of rubber and/or rigid plastic. In one example embodiment, the pipe 202 to structure connection device 102 is a rubber seal that’s cast into the structure wall of the support structure 200. In one example embodiment, the support structure 200 is a concrete manhole, and/or a pipe or wall that has a gasket that is cast or attached into the connection hole where the adapter and pipe slide into. In one or more example embodiments, the connection device 102 is formed by one of extrusion, splicing, and/or injection molding. In one example embodiment, the connection device 102 defines a t-shape 102a for residing within or connecting to the support structure 200. In another example embodiment, the connection device 102 defines one or more voids 102b that provide structure and flexibility to the connection device. In one example embodiment, the connection device 102 is integrally coupled to the adaptor body 104. In another example embodiment, the connection device 102 is selectably couplable to the adaptor body 104. In this example embodiment, the connection device 102 is formed by injection molding and/or thermoforming.

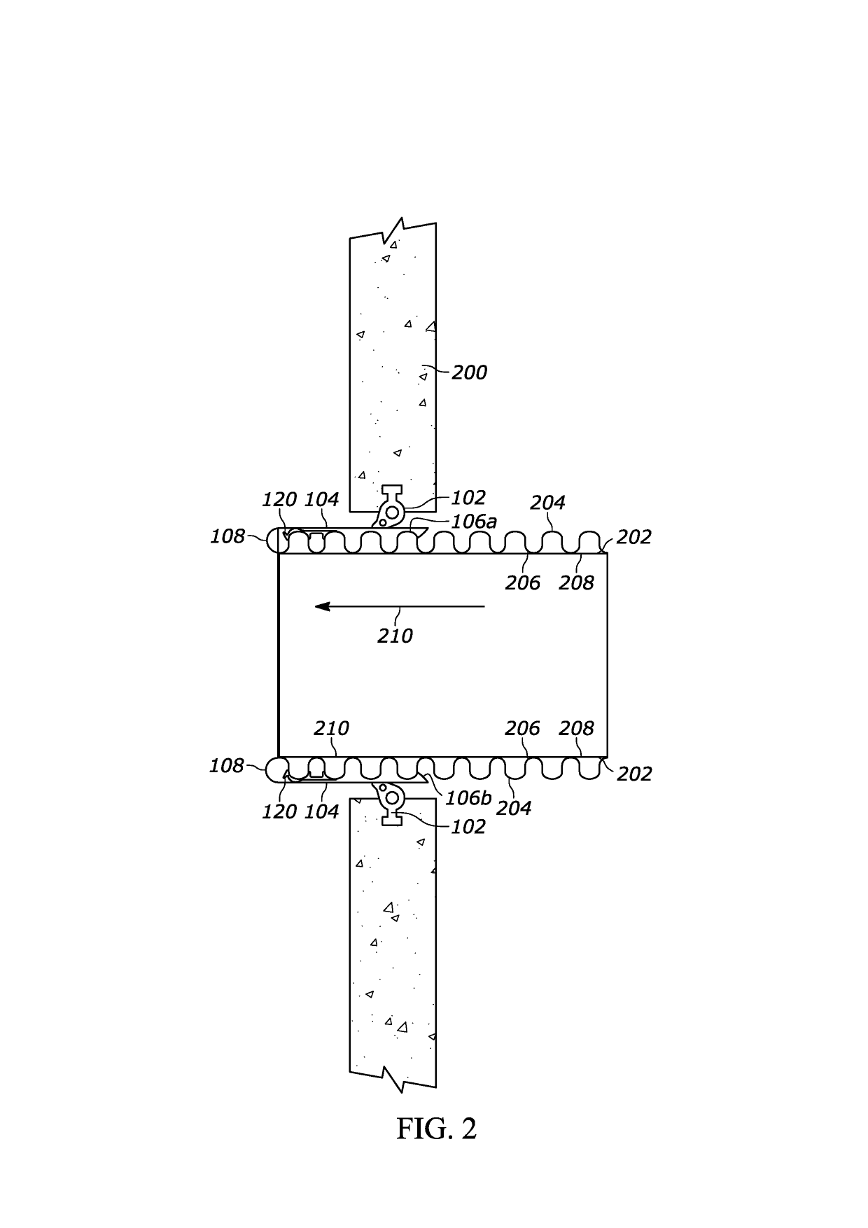

In the illustrated example embodiment of FIG. 2, the assembly 100 has additional elements present relative to the assembly 100 of FIG. 1. In the example embodiment of FIG. 2, the assembly 100 includes a rounded inlet 108. In this example embodiment, the rounded inlet 108 is formed on the lead end 114 of the adaptor body 104 and interacts with the leading face 205 of the connecting pipe 202. In this example embodiment, the rounded inlet 108 creates a hydraulic improvement by providing a rounded leading edge to improve fluid entrance into the connecting pipe 202. This rounded inlet 108 improves flow from the structure 200 to the connecting pipe 202. In this example embodiment, the rounded inlet 108 is formed from the same material and in the same manner as the adaptor body 104.

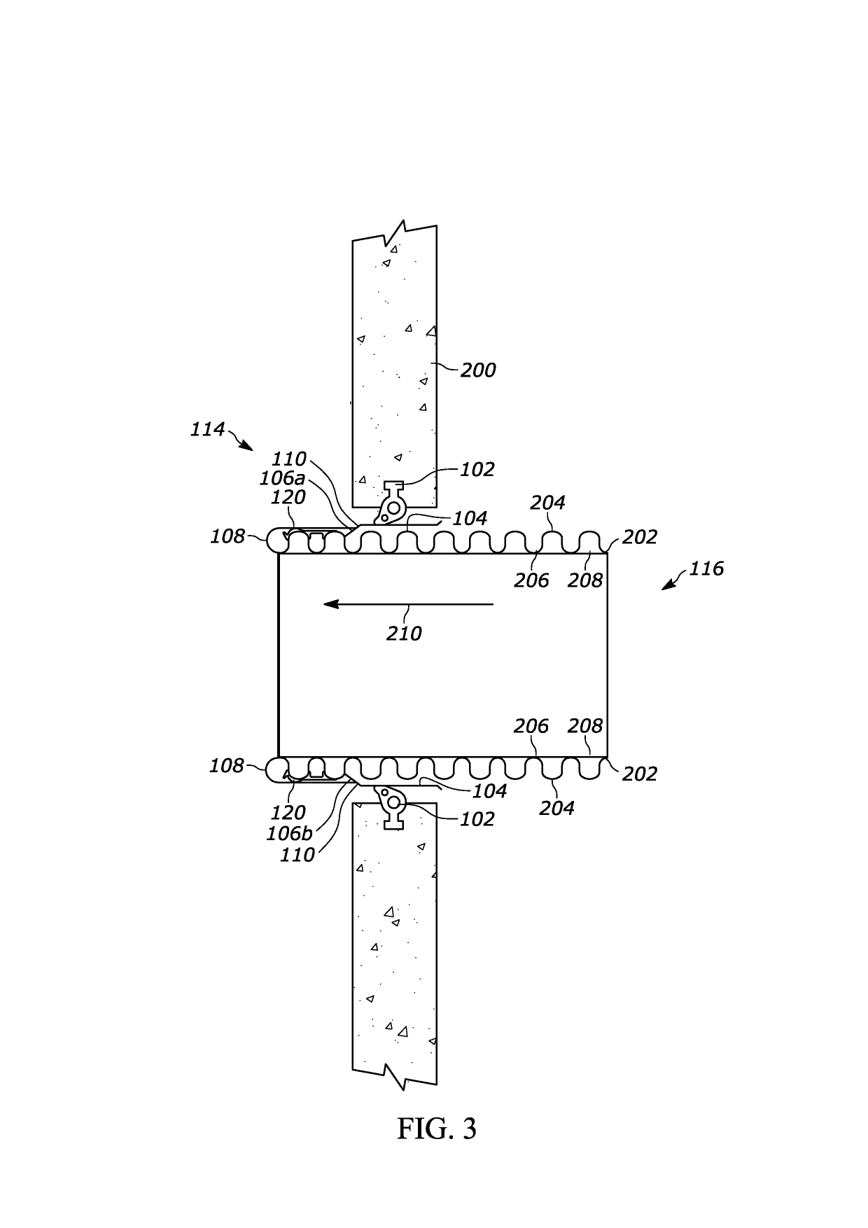

In the illustrated example embodiment of FIG. 3, the assembly 100 has additional elements present relative to the assembly 100 of FIG. 1 and FIG. 2. In the example embodiment of FIG. 3, the adaptor body 104 includes a step 110. In this example embodiment, the step 110 is formed in the adaptor body 104, wherein the width of diameter 105b of the adaptor body is increased at the location of the step, wherein the step gradually increases the width or diameter, and then extends substantially parallel to the adaptor body prior to the step defining a new larger width or diameter. In one example embodiment, the step 110 is formed at or near the one or more cleats 106, such that the one or more cleats are between the rounded inlet 108 and the step. In this example embodiment, the step 110 allows for design adjustments to the width or diameter 105b of the adaptor body 104 to connect the existing structure to the connecting pipe 202. Therefore, the connecting pipe 202 having variable widths or diameters can be used without the need to develop a pipe to structure connection device specific to that pipe. In this example embodiment, the step 110 is formed from the same material and in the same manner as the adaptor body 104.

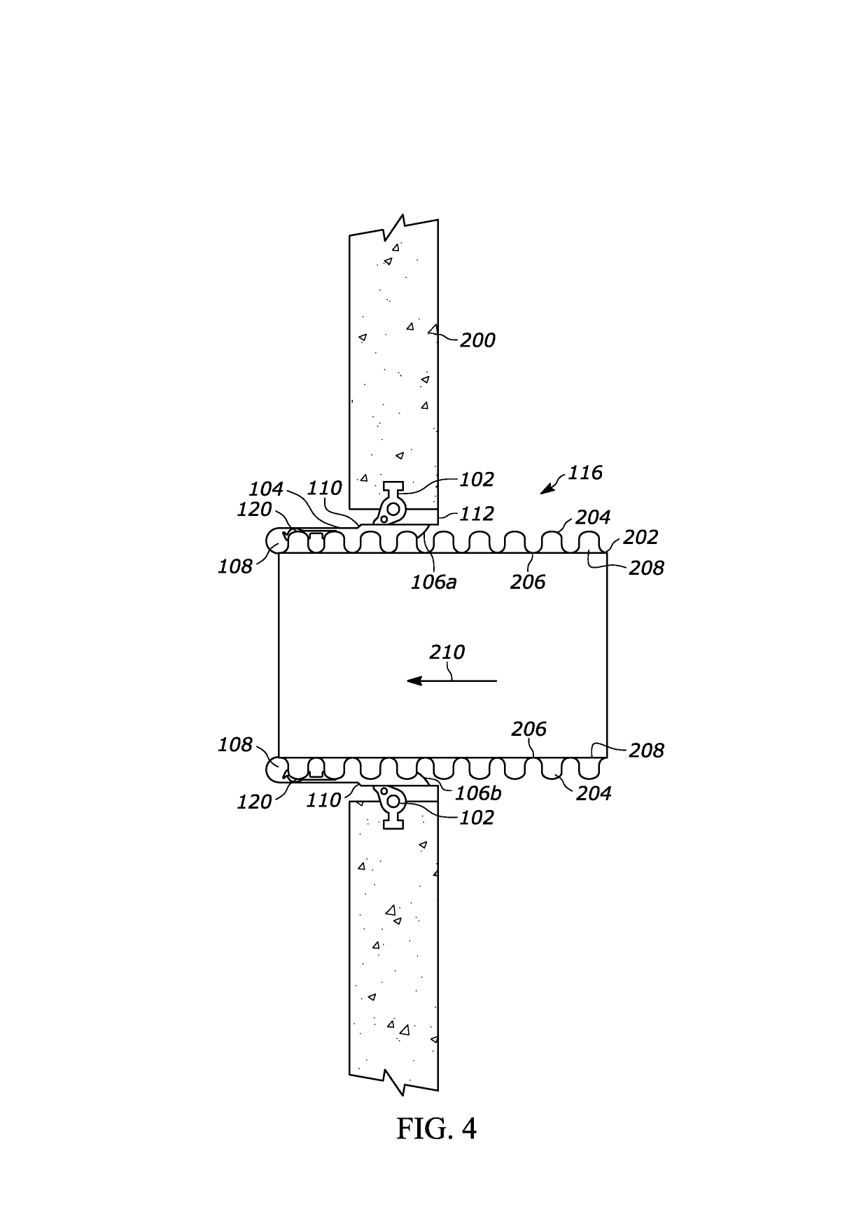

In the illustrated example embodiment of FIG. 4, the assembly 100 has additional elements present relative to the assembly 100 of FIGS. 1-3. In the example embodiment of FIG. 4, the adaptor body 104 includes a stop 112 at the rear end 116 of the adaptor body 104. In this example embodiment, the stop 112 extends from the rear end 116 of the adaptor body 104 at an angle transverse or perpendicular to the assembly direction 210 and/or the inner or outer surfaces 104a, 104b of the adaptor body. In this example embodiment, the stop 112 extends around a portion or the totality of the adaptor body 104. In another example embodiment, the stop 112 extends between four (4) inches and thirty-six (36) inches away from the outer surface 104b of the adaptor body 104. In this example embodiment, the stop 112 interacts with a wall of the support structure 200 to prevent the over assembly of the connecting pipe 200, thus increasing a reliability of the assembly 100 by reducing user error. In this example embodiment, the stop 112is formed from the same material and in the same manner as the adaptor body 104.

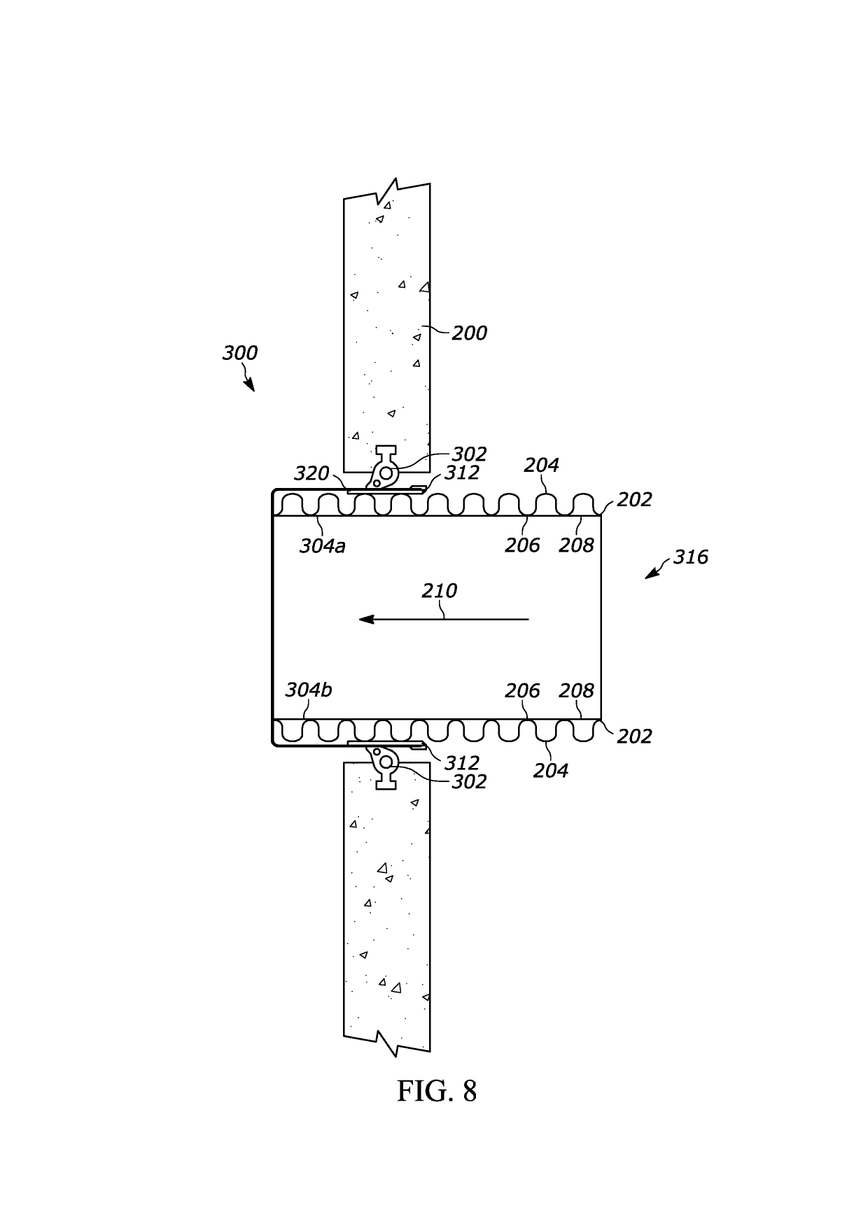

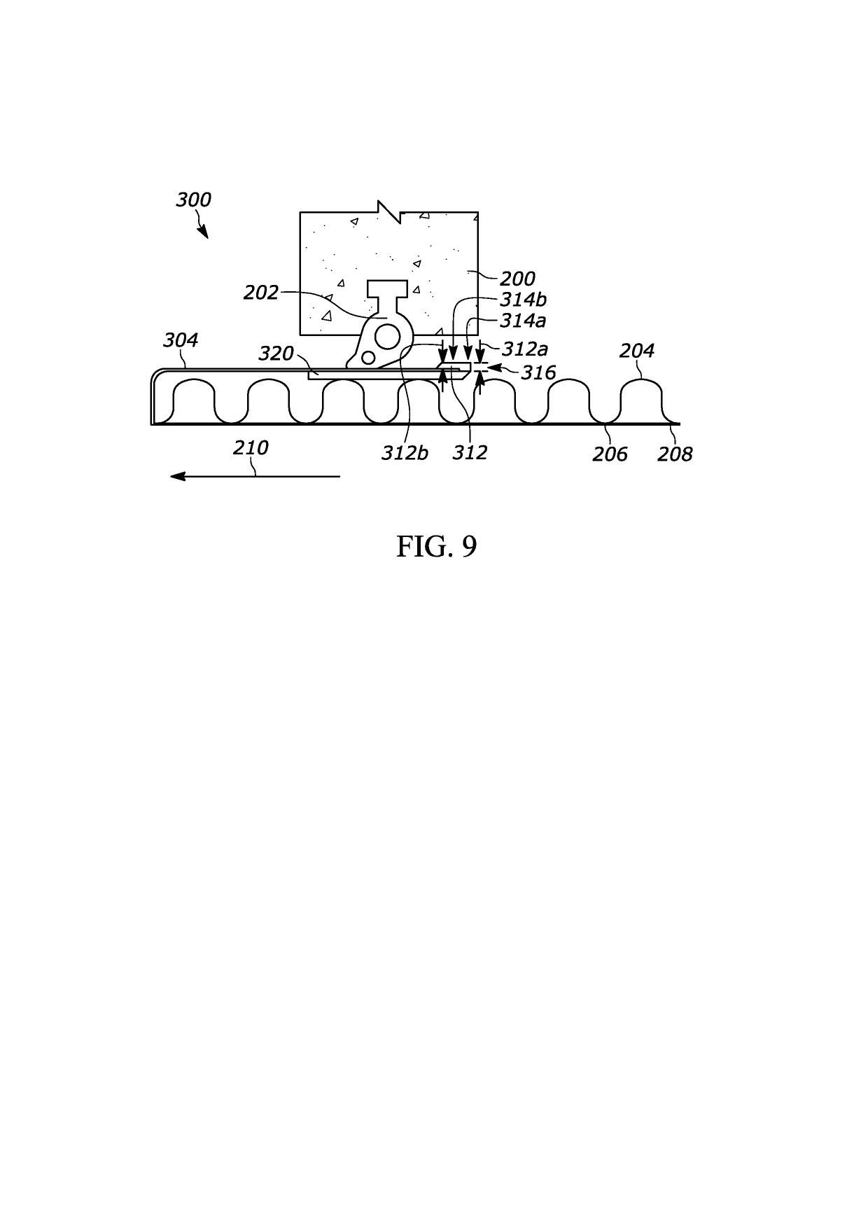

Referring to FIGS. 8-9 a second embodiment of the assembly 300 is provided according to another example embodiment of the present disclosure. The assembly 100 in FIG. 1-7 are substantially similar to the assembly 300 in FIGS. 8-9 with shared features being identified by the same numeral increased by 200. That is, in the second embodiment illustrated in FIGS. 8-9, the assembly 200 comprises all of the features of the plurality of assembly 100 except as described in greater detail below. Illustrated in FIG. 8, is a cross-sectional view of the assembly 300 coupled to a corrugated pipe 202, the assembly constructed in accordance with one embodiment of the disclosure forming a sealing and fluid-tight connection between the assembly 300 and the first corrugated pipe 202. The assembly 300 includes a connector device 302 couplable to a connecting structure 200, and an adaptor body 304 coupled to the connector device. In one example embodiment, a gasket 320 is coupled to the adaptor body 304. In another example embodiment, the gasket 320 is a separate or discrete structure from the adaptor body 304.

In the illustrated example embodiment, the gasket 320 is an annular body formed of a unitary, tubular configuration that is circumferentially positioned around one or more gasket corrugations. In one example embodiment, the gasket 320 is made of one of Thermoplastic Elastomer (TPE), High Density Polyethylene (“HDPE”) and/or rigid polypropylene plastic. In one example embodiment, the gasket 120 is made of Thermoplastic Elastomer (TPE). In one example embodiment, the TPE includes polypropylene. In one example embodiment, the TPE has a range of 40 to 90 shore A. In another example embodiment, the TPE has a hardness of 55 shore A.

The gasket 320 is positioned along the interior surface of the adaptor body 304 and functions as a sealing interface with the first corrugated pipe 202. In one example embodiment, the gasket 320 spans a minimum length corresponding to at least three corrugation pitches (e.g., wherein each pitch is a peak of one peak 204 to the peak of one adjacent peak 204). This configuration ensures that at least two peaks 204 remain in continuous contact with the gasket 320, thereby maintaining reliable sealing. In this example embodiment, the gasket 320 is co-extruded with a stop 312, described below, to form an integrated sealing and positioning element.

In another example embodiment, the gasket 320 is annular and unitary with the stop 312 such that it cannot be separated without destroying the gasket. In another example embodiment, the gasket 320 is annular, unitary, and formed by extruding or molding one material or multiple materials together such that the materials are integrally connected. While in yet another example embodiment, the gasket 320 and stop 312 are annular, unitary, and formed by extruding, co-extruding, tri-extruding, or multi-extruding one or more materials integrally together in a linear fashion such that the gasket has first and second ends that are integrally connected at a seam by welding, fusing, bonding, or any combination thereof to form an annular and unitary gasket, eliminating the first end and second end such that that annular, unitary, integrally connected gasket 320 cannot be separated without destroying the gasket. In another example embodiment, the integral connection of the first and second ends at the seam is substantially flash free and incapable of being detected by the human eye as would be appreciated by one of ordinary skill in the art after reviewing the present disclosure, accompanying drawings, and patent(s) owned by the assignee and/or inventor of the subject application on gaskets and joining of gaskets, which are incorporated herein by reference in their entireties.

In the example embodiment of FIGS. 8-9, the adaptor body 304 includes a stop 312 at a rear end 316 of the adaptor body 304. In this example embodiment, the stop 312 extends from the rear end 316 of the adaptor body 304 at an angle transverse or perpendicular to the assembly direction 210 and/or extends beyond a diameter of the adaptor body 304. In this example embodiment, a shape of the stop 312 creates a feature that performs several functions. In this example embodiment, the stop 312 is formed from a thermoplastic elastomer material selected to be compatible with the adaptor body 304 material, enabling the stop to be welded to the sleeve. In another example embodiment, the stop 312 is co-extruded with the gasket 320 to form a single integrated component, which is subsequently affixed to the adaptor body 304 using a secondary welding process. In this example embodiment, the stop 312 has a first portion 314a having a first width 312a and a second portion 314b having a second width 312b. In this embodiment the first width 312a is greater than the second width 312b. In the illustrated example embodiment, the first portion 314a is in contact with the gasket 320. In the illustrated example embodiment, the first portion 314a is in coupled to the gasket 320 as described above. In this example embodiment, the second portion 314b is spaced from the gasket 320. In another example embodiment, when in use, the second portion is in contact with and/or coupled to the adapter body 304. In one example embodiment, geometry and dimensions of the stop 312 are designed to serve multiple purposes, including: providing a visual indicator that allows the installer to confirm proper positioning of the pipe 202 and the adaptor body 204 during installation. Further, the stop 312 indicates when the adaptor body 204 has reached the correct installation depth relative to the exterior surface of the concrete structure, generally corresponding to a position flush with or tangent to the exterior structural surface 200. In this example embodiment, the stop 312 extends around a portion or the totality of the adaptor body 304. In another example embodiment, the stop 312 extends between four (4) inches and thirty six (36) inches away from the outer surface 304b of the adaptor body 304. In this example embodiment, the stop 312 interacts with the rear end 316 of the adaptor body 304 to prevent the over assembly of the connecting pipe 200, thus increasing a reliability of the assembly 300 by reducing user error. In this example embodiment, the stop 312 has a has a range of 80 to 85 shore A.

It would be understood that the stop 112, the gasket 120, could be substituted or added into the assembly 300, to either replace the stop 312 or the gasket 320, or the one. or more locking cleats 106 could be added to the assembly 300 in any configuration described herein.

Advantageously, the assembly 100, 300 described herein solves many of the challenges with coupling pipes to existing connections to structures. The assembly 100, 300 increases flow into the connecting pipe 202 by reducing the inlet coefficient by up to 20%. This increased flow is critical in the prevention of flooding during extreme storm events. Additionally, the adaptor body 304 is designed to be rigid enough to allow forces of assembly into the connecting pipe 200 but flexible enough to allow the transfer of circumferential compressive force created by the stop 302 to the adaptor body 304, and then transferring the force to the gasket 320, which ultimately create sufficient sealing on a crown of the corrugations 204 to form a water tight seal.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non- exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 100%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A piping connection system, the piping connection system comprising:
an annular adaptor body having a unitary configuration that is to be circumferentially positioned around a connecting pipe during use, the annular adaptor body further comprising:
at least one cleat extending along an inner wall of the annular adaptor body, the at least one cleat transverse to the inner wall; and
a connecting device extending from an exterior surface of the annular adaptor body, the connecting device for coupling to support structure; and
a gasket having a unitary configuration that is to be circumferentially positioned around a connecting pipe during use, the gasket in contact with the interior surface during said use.

2. The pipe connection system of claim 1, wherein the adaptor body further comprises a rounded inlet at a leading end of the adaptor body, the rounded inlet in contact with a leading face of the connecting pipe during use,

3. The pipe connection system of claim 2, wherein, the rounded inlet extending annularly around the leading face of the adaptor body.

4. The pipe connection system of claim 1, wherein the adaptor body further comprises a step that increases a diameter of the adaptor body, such that the adaptor body has a lesser diameter at a leading end of the adaptor body relative to a terminal end of the adaptor body.

5. The pipe connection system of claim 4, further wherein the step extending annularly around the adaptor body.

6. The pipe connection system of claim 1, wherein the adaptor body further comprises a stop at a terminal end of the adaptor body

7. The pipe connection system of claim 6, wherein, the stop extends parallel to the exterior surface of the adaptor body and extending at least one of partially or totally around the annular adaptor body.

8. A piping connection system, the piping connection system comprising:
an annular adaptor body having a unitary configuration that is to be circumferentially positioned around a connecting pipe during use, the annular adaptor body further comprising a rounded inlet at a leading end of the adaptor body, the rounded inlet in contact with a leading face of the connecting pipe during use, wherein, the rounded inlet extending annularly around the leading face of the adaptor body; and
a gasket having a unitary configuration that is to be circumferentially positioned around a connecting pipe during use, the gasket in contact with the interior surface during said use.

9. The pipe connection system of claim 8, the annular adaptor body further comprising at least one cleat extending along an inner wall of the annular adaptor body, the at least one cleat transverse to the inner wall.

10. The pipe connection system of claim 8, the annular adaptor body further comprising a connecting device extending from an exterior surface of the annular adaptor body, the connecting device for coupling to support structure.

11. The pipe connection system of claim 8, wherein the adaptor body further comprises a step that increases a diameter of the adaptor body, such that the adaptor body has a lesser diameter at a leading end of the adaptor body relative to a terminal end of the adaptor body.

12. The pipe connection system of claim 11, further wherein the step extending annularly around the adaptor body.

13. The pipe connection system of claim 8, wherein the adaptor body further comprises a stop at a terminal end of the adaptor body

14. The pipe connection system of claim 13, wherein, the stop extends parallel to the exterior surface of the adaptor body and extending at least one of partially or totally around the annular adaptor body.

15. A piping connection system, the piping connection system comprising:
an annular adaptor body having a unitary configuration that is to be circumferentially positioned around a connecting pipe during use, the annular adaptor body further comprising a stop at a terminal end of the adaptor body, wherein, the stop extends parallel to an exterior surface of the adaptor body and extending at least one of partially or totally around the annular adaptor body; and
a gasket having a unitary configuration that is to be circumferentially positioned around a connecting pipe during use, the gasket in contact with the interior surface during said use.

16. The pipe connection system of claim 15, the annular adaptor body further comprising at least one cleat extending along an inner wall of the annular adaptor body, the at least one cleat transverse to the inner wall.

17. The pipe connection system of claim 16, the annular adaptor body further comprising a connecting device extending from the exterior surface of the annular adaptor body, the connecting device for coupling to support structure.

18. The pipe connection system of claim 15, the annular adaptor body further comprising at least one cleat extending along an inner wall of the annular adaptor body, the at least one cleat transverse to the inner wall.

19. The pipe connection system of claim 15, the annular adaptor body further comprising a connecting device extending from an exterior surface of the annular adaptor body, the connecting device for coupling to support structure.

20. The pipe connection system of claim 15, wherein the adaptor body further comprises a step that increases a diameter of the adaptor body, such that the adaptor body has a lesser diameter at a leading end of the adaptor body relative to the terminal end of the adaptor body, further wherein the step extending annularly around the adaptor body.
